(19) United States
(12) Patent Application Publication
(10) Pub. No.: US 2025/0215218 A1
(43) Pub. Date: Jul. 3, 2025

(54) EE Device Comprising a Composite Polycarbonate Element Having High CTI

(71) Applicant: Covestro Deutschland AG, Leverkusen (DE)

(72) Inventors: Matthias Knaupp, Langenfeld (DE); Tim Hungerland, Köln (DE); Marius Nolte, Köln (DE); Constantin Schwecke, Alfter (DE)

(21) Appl. No.: 18/849,652

(22) PCT Filed: Mar. 20, 2023
(86) PCT No.: PCT/EP2023/057005

§ 371 Date: Sep. 23, 2024

(30) Foreign Application Priority Data
Mar. 25, 2022 (EP) 22164388.5

(51) Int. Cl. C08L 69/00; C08K 5/523; C08K 5/5399; H02G 5/02

(52) U.S. Cl. CPC C08L 69/00; C08K 5/523; C08K 5/5399; H02G 5/025; C08L 2201/02; C08L 2203/20

(57) ABSTRACT

The invention relates to an EE device including depending on the operating voltage applied, different distance ranges between the electrical conductors, the distances being so small that already the material used between the electrical conductors results in a very high comparative tracking index. Surprisingly, this material is a polycarbonate-based material the comparative tracking index of which is significantly increased when relatively small amounts of fluorine-containing anti-dripping agent and phosphorus-based retardant are added.

### CROSS-REFERENCE TO RELATED APPLICATIONS

This application is the United States national phase of International Patent Application No. PCT/EP2023/057005 filed Mar. 20, 2023, and claims priority to European Patent Application No. 22164388.5 filed Mar. 25, 2022, the disclosures of which are hereby incorporated by reference in their entireties.

### BACKGROUND

### Technical Field

The invention relates to EE components made of a polymer material having high tracking current resistance.

### Description of Related Art

In applications in which the plastic is in direct contact with the electrical conductor paths, a high resistance to tracking currents under voltage load is a prerequisite, in order for there not to be any short circuits within the component and hence a fire. The comparative tracking index (CTI) describes in general the resistance of a plastics material to environmental influences. The CTI value is a measure of the inclination of a plastic, under environmental influences, such as moisture and soiling, to form under voltage electrically conductive paths on the surface and promote resulting electrical tracking currents. The higher the tracking current resistance or the comparative tracking index (CTI value) of a material, the better suited it is for use in high-voltage applications, for example in modern-day electromobility applications. Another advantage of materials having a high CTI value is the possibility of placing electrical conductor paths in an EE component closer together without risking a short circuit, which in turn enables the reduction of component dimensions and thus more compact designs and weight savings.

A material which is fundamentally of interest as polymer material, for example because of its high impact resistance and high heat distortion resistance, but has not been considered to date for such applications because of its intrinsically low tracking current resistance is polycarbonate. In contrast to other thermoplastic polymers such as polystyrene, polyester, etc., polycarbonate itself has a very low comparative tracking index. Due to the high proportion of aromatic structures, polycarbonate has a rather high tendency to carbonize. The CTI of pure polycarbonate is about 250 V or even lower (F. Acquasanta et al., Polymer Degradation and Stability, 96 (2011), 2098-2103).

For numerous applications in the electronics/electrical sector (EE), for example in the field of electromobility, a relatively high CTI of the materials used is required for safety reasons alone. This is because, for example, housings made of a material, in the event of a collision, for example because of an accident, can be dented and hence come into contact with electrical conductors and may form a bridge between these. In such a case, no short circuit should arise if at all possible. Other applications are run per se at voltages of 400 V or higher, such that correspondingly tracking current-resistant materials are required. In the region of E-mobility, the current standard, for example, given the rapid charging times required is already an operating voltage of 400 V; a further increase is likely. Polycarbonate has therefore to date not been considered as a material for a multitude of applications that specifically require a high comparative tracking index of the material.

The higher the tracking current resistance of a material, the smaller the distances that can be achieved between the electrical conductors of an EE component depending on the operating voltage applied. This is important in the case of batteries, for example, since even a reduction in the distances between two conductors of a few fractions of a millimeter causes a considerable rise in the capacity or energy density of the battery. At the same time, the use of polycarbonate, which is otherwise attractive, for corresponding EE applications as well would be desirable.

The problem addressed was thus that of providing EE components with a polycarbonate material connecting the electrical conductors that has a high CTI of at least 400 V, preferably of 600 V, preferably determined by the rapid test method in accordance with IEC 60112:2009. Due to the area of application and the heat development in EE components, the thermoplastic compositions used should preferably also have a good heat distortion resistance, in particular a Vicat softening temperature, determined according to ISO 306:2014-3, VST Method B, of at least 100° C., preferably of at least 115° C.

It has been found that, surprisingly, polycarbonate-based compositions containing bisphenol A-based polycarbonate and fluorine-containing anti-drip agent and phosphorus-containing flame retardant in particular amounts have such a high tracking current resistance that it is possible using these polycarbonate compositions between two electrical conductors of a component to achieve smaller distances than was conceivable to date with use of polycarbonate. This was particularly surprising since polycarbonate intrinsically has low tracking current resistance, and the amounts of the additives added are relatively low compared to the polycarbonate content of the resulting compositions.

### SUMMARY

The invention therefore provides an EE component comprising
a first electrical conductor and a second electrical conductor at a first distance d1 and a second distance d2 with respect to one another,
which are connected via a thermoplastic composition Z which is in direct contact with the first electrical conductor and the second electrical conductor,
wherein the distance d1 is the shortest distance between the first electrical conductor and the second electrical conductor along the surface of the thermoplastic material M and
wherein the distance d2 is the shortest distance between the first electrical conductor and the second electrical conductor through the air, wherein d2 is selected in such a way that at the respective operating voltage a sparkover through the air is prevented,
wherein d1, at the operating voltage U listed below, is:

$$d 1 i ( 0 V \leq U \leq 250 V ) : 1.3 mm to < 2.5 mm \\ d 1 ii ( 250 V < U \leq 500 V ) = 2.5 mm to < 5. mm \\ d 1 iii ( 500 V < U \leq 1000 V ) = 5. mm to < 10. mm$$

and wherein the thermoplastic composition Z comprises the following components:
A) at least 80% by weight of aromatic polycarbonate based on bisphenol A,
B) 0.25% by weight to 5% by weight of fluorine-containing anti-drip agent containing polytetrafluoroethylene,
C) at least 2% by weight of phosphorus-containing flame retardant,
   wherein the quotient of the amount of phosphorus-containing flame retardant and the amount of PTFE is ≤40 and
   wherein, when the phosphorus-containing flame retardant is
   b1) an organophosphate,
   the amount of phosphorus-containing flame retardant is 2% to 12% by weight,
   and, when the phosphorus-containing flame retardant is
   b2) a phosphazene,
   the amount of phosphorus-containing flame retardant is 2% to 9% by weight,
and wherein the thermoplastic composition Z is free of flame retardants selected from the group of alkali metal, alkaline earth metal or ammonium salts of aliphatic or aromatic sulfonic acid, sulfonamide or sulfonimide derivatives.

Such small lower limits for the distances between the electrical conductors are achievable only with a material having at least a CTI of 600 V. Even the upper limit of these small separation ranges can only be achieved when the material used has at least a CTI of 400 V.

Even the separation ranges detailed below are thus achievable at the specified operating voltages only when the material has a CTI of at least 400 V:

$$d 1 i ( 0 V \leq U \leq 250 V ) : 1.8 mm to < 2.5 mm \\ d 1 ii ( 250 V < U \leq 500 V ) = 3.6 mm to < 5. mm \\ d 1 iii ( 500 V < U \leq 1000 V ) = 7.1 mm to < 10. mm .$$

More preferably, d1 when a material having a CTI of 600 V is used, as described as part of the invention, at the listed operating voltage is:
d1i (0 V≤U≤250 V): 1.3 mm to <1.8 mm,
d1ii (250 V<U≤500 V)=2.5 mm to <3.6 mm,
d1iii (500 V<U≤1000 V)=5.0 mm to <7.1 mm, distances that are not achievable even with a material
with a CTI of 400 V or 450 V, but require a CTI of 600 V.

It is thus possible to achieve EE components with polycarbonate material between two electrical conductors having smaller distances than considered possible to date.

The selection of d2 is within the ability of those skilled in the art. Preferably, d2 is at least 1.2 mm.

It is well known that the degree of soiling affects the electrical conductivity. The distances d1 and d2 mentioned are usable in practice in components in which, for example due to structural shielding, an IP6K9K degree of protection according to ISO 20653:2013-02 is adhered to.

The thermoplastic compositions used for the EE component of the invention constitute such a selection that, because of the high tracking current resistance, they can be assigned to insulation group II (400 V≤CTI<600 V), very particularly preferably to insulation group I (600 V≤CTI), classified in accordance with DIN EN 60664-1.

The EE component of the invention, because of the high tracking current resistance of the material used, is preferably used for EE assemblies designed for an operating voltage of at least 400 V, possibly even 600 V. Corresponding EE assemblies thus also form part of the subject matter of the invention.

The EE component of the invention is preferably part of a high-voltage switch, inverter, relay, electronic connector, electrical connector, circuit breaker, a photovoltaic system, an electric motor, a heat sink, a charger or charging plug for electric vehicles, an electrical junction box, a smart meter housing, a miniature circuit breaker, a busbar. What is meant here by “part of a” is that this may be an individual element of a complex product, of a component group, but likewise such that it may be the entire element, as in the case, for example, of “electronic connectors”.

The thermoplastic composition Z which is used for the EE component of the invention necessarily comprises components A, B and C. It is optionally possible to add further components too, for example additives according to component D, provided that they do not have an adverse effect on the desired effect of high tracking current resistance.

The invention also provides for the use of corresponding compositions for achievement of a CTI of at least 600 V. It will be apparent that the preferred, further-preferred, particularly preferred etc. embodiments that have been described for the EE component and in some cases also relate to aspects of the thermoplastic composition Z are also applicable to the use of the invention.

Such a specific use also exists, for example, when a corresponding composition Z is used for an insulation layer which, because of the application, requires a CTI of 600 V. Such an insulation layer can for example be provided on an inverter as a layer to protect against external influences. For inverters, standard insulation materials are those having a CTI of 600 V. The composition according to the invention may also be used as an insulation layer for other electrical components, for example transistors. The electrical components of a transistor are protected by overmolding with a plastic having high CTI. The plastic protects the electrical components both from contact and from unwanted electrical interaction with adjoining metallic components-such as a metallic heat sink- or electrical components.

Another reason why transistors are frequently applied directly to a heat sink is because of the high heat development in operation. Here too, the thermoplastic composition Z introduced between heat sink and transistor ensures safe operation.

A further field of use is that of mounting brackets for busbars, where it is likewise necessary to use materials having a high CTI. The mounting brackets have essentially two functions: fixing of the busbars in the component group in order to prevent any change in position in operation, and action as spacers, in order to be able to run several busbars in parallel, where it is necessary here too for a sufficiently large distance to be chosen between the two busbars to prevent sparkover through air. In addition, however, tracking on the surface of the mounting bracket must be prevented between the busbars, but also between the busbar and other metallic components, for example the screws for securing the mounting brackets on the structure beneath. Mounting brackets having a high CTI can increase component density and energy density here.

In the case of plug connectors, plug devices and sockets, there is a high risk of tracking current formation that can lead to electrical failure and possible fire. A housing that seals current-conducting wires can improve the situation, since the risk of soiling is low. Plug connectors for charging devices or else USB-C plug connectors have an elevated risk since the current-conducting conductor paths cannot be covered or sealed and, moreover, are exposed to soiling such as perspiration, moisture, fabric particles, dust and other materials. A high-CTI material is needed to offer sufficient protection from tracking, but also in order to enable miniaturization or an increase in power density.

### DETAILED DESCRIPTION

The components mentioned in the composition used in accordance with the invention are elucidated in detail hereinafter:

### Component A

Component A of the thermoplastic compositions of the invention is bisphenol A-based polycarbonate. What is preferably meant by “bisphenol A-based” is that the polycarbonate comprises at least 50% by weight, more preferably at least 70% by weight, even more preferably at least 90% by weight, of monomer units based on bisphenol A.

Preferably, component A is bisphenol A homopolycarbonate, i.e. an aromatic polycarbonate based on the sole monomer unit bisphenol A.

The melt volume flow rate MVR of the aromatic bisphenol A homopolycarbonate used, determined according to ISO 1133:2012-03, at a test temperature of 300° C. and with 1.2 kg load, is preferably 5 to 35 cm³/(10 min), more preferably 6 to 21 cm³/(10 min), particularly preferably 10 to 19 cm³/(10 min), very particularly preferably 11 to 15 cm³/(10 min). If different polycarbonates are used, these values are based on the mixture of bisphenol A homopolycarbonates.

Details of the preparation of polycarbonates have been set out in many patent specifications over the past 40 years or so. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718 and finally to U. Grigo, K. Kirchner and P. R. Müller “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117 to 299.

Aromatic polycarbonates are prepared, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Likewise possible is preparation via a melt polymerization process, by reacting dihydroxyaryl compounds with, for example, diphenyl carbonate.

In the case of bisphenol A homopolycarbonate, solely bisphenol A is used as dihydroxyaryl compound.

In the preparation of the bisphenol A homopolycarbonate, preferred chain terminators are phenols having substitution by one or more linear or branched, preferably unsubstituted, C₁—to C₃₀-alkyl radicals, or by tert-butyl. Particularly preferred chain terminators are phenol, cumylphenol and/or p-tert-butylphenol. The amount of chain terminator to be used is preferably 0.1 to 5 mol %, based on moles of dihydroxyaryl compounds used in each case. The chain terminators may be added before, during or after the reaction with a carbonic acid derivative.

In principle, the homopolycarbonate may also be branched.

Suitable branching agents are the trifunctional or more than trifunctional compounds known in polycarbonate chemistry, in particular those having three or more than three phenolic OH groups.

Examples of suitable branching agents include 1,3,5-tri (4-hydroxyphenyl)benzene, 1,1,1-tri (4-hydroxyphenyl) ethane, tri (4-hydroxyphenyl)phenylmethane, 2,4-bis(4-hydroxyphenylisopropyl) phenol, 2,6-bis(2-hydroxy-5′-methylbenzyl)-4-methylphenol, 2-(4-hydroxyphenyl)-2-(2,4-dihydroxyphenyl) propane, tetra(4-hydroxyphenyl) methane, tetra(4-(4-hydroxyphenylisopropyl) phenoxy) methane and 1,4-bis((4′,4″-dihydroxytriphenyl)methyl)benzene and 3,3-bis(3-methyl-4-hydroxyphenyl)-2-oxo-2,3-dihydroindole.

The amount of the branching agents for optional use is preferably from 0.05 mol % to 2.00 mol % based on moles of bisphenol A used in each case.

The branching agents may either be initially charged together with the bisphenol A and the chain terminators in the aqueous alkaline phase or be added as a solution in an organic solvent before the phosgenation. In the case of the transesterification process, the branching agents are used together with the bisphenol A.

The thermoplastic compositions of the invention contain at least 80% by weight, preferably at least 83% by weight, particularly preferably at least 90% by weight, of aromatic bisphenol A-based polycarbonate, preferably bisphenol A homopolycarbonate, and are thus based on such aromatic polycarbonate.

### Component B

The thermoplastic compositions Z contain, as component B, a fluorine-containing anti-drip agent containing polytetrafluoroethylene (PTFE), which may be a mixture of two or more anti-drip agents. The total amount of anti-drip agent (anti-dripping agent) is 0.25% by weight to 5% by weight, preferably 0.4% by weight to 1.6% by weight, particularly preferably 0.045% by weight to 1.0% by weight of at least one anti-drip agent.

The anti-drip agent used is preferably fluorine-containing polyolefin containing polytetrafluoroethylene.

The fluorinated polyolefins used with preference as anti-drip agents and containing polytetrafluoroethylene have high molecular weight and have glass transition temperatures of above −30° C., generally of above 100° C., and fluorine contents preferably from 65% by weight to 76% by weight, in particular from 70% to 76% by weight. Preferred fluorinated polyolefins are polytetrafluoroethylene, polyvinylidene fluoride, tetrafluoroethylene/hexafluoropropylene copolymers and ethylene/tetrafluoroethylene copolymers. Fluorinated polyolefins are known (cf. “Vinyl and Related Polymers” by Schildknecht, John Wiley & Sons, Inc., New York, 1962, pages 484-494; “Fluoropolymers” by Wall, Wiley-Interscience, John Wiley & Sons, Inc., New York, volume 13, 1970, pages 623-654; “Modern Plastics Encyclopedia”, 1970-1971, volume 47, No. 10 A, October 1970, McGraw-Hill, Inc., New York, pages 134 and 774; “Modern Plastics Encyclopedia”, 1975-1976 Oct. 1975, volume 52, No. 10 A, McGraw-Hill, Inc., New York, pages 27, 28 and 472 and US 3,671,487 A, 3 723 373 A and 3 838 092 A). They can be prepared by known methods, for example by polymerizing tetrafluoroethylene in aqueous medium with a free-radical-forming catalyst, for example sodium, potassium or ammonium peroxydisulfate, at pressures of from 7 to 71 kg/cm² and at temperatures of from 0 to 200° C., preferably at temperatures of from 20 to 100° C. More details are given, for example, in U.S. Pat. No. 2,393,967 A.

Depending on the use form, the density of the fluorinated polyolefins may be between 1.2 and 2.3 g/cm³, preferably 2.0 to 2.3 g/cm³, determined according to ISO 1183-1 (2019-09), and the average particle size between 0.05 and 1000 μm, determined by means of light microscopy or white light interferometry.

Suitable tetrafluoroethylene polymer powders are commercial products and are available by way of example from DuPont under the trade name Teflon®.

Particular preference is given to using polytetrafluoroethylene (PTFE), as such, but also in the form of a PTFE-containing composition, as fluorine-containing anti-drip agent. If a PTFE-containing composition is used, the minimum use amount thereof is sufficient for at least 0.25% by weight of PTFE to be present in the overall composition. The PTFE-containing compositions include Hostaflon® TF2021 or PTFE blends such as Blendex® B449 (about 50% by weight of PTFE and about 50% by weight of SAN [from 80% by weight of styrene and 20% by weight of acrylonitrile]) from Chemtura. Very particular preference is given to using PTFE or SAN-encapsulated PTFE as fluorine-containing anti-drip agent.

### Component C

Component C of the compositions according to the invention is phosphorus-containing flame retardants. It may be a single phosphorus-containing flame retardant, but it may also be a mixture of various phosphorus-containing flame retardants.

Preferred phosphorus-containing flame retardants are cyclic phosphazenes, phosphorus compounds of the formula (10), and mixtures thereof:

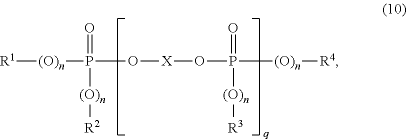

in which
R¹, R², R³ and R⁴ are independently a C₁—to C₈-alkyl radical, in each case optionally halogenated and in each case branched or unbranched, and/or C₅—to C₆-cycloalkyl radical, C₆—to C₂₀-aryl radical or C₇—to C₁₂-aralkyl radical, in each case optionally substituted by branched or unbranched alkyl, and/or halogen, preferably chlorine and/or bromine,
n is independently 0 or 1,
q is a value from 0 to 30 and
X is a mono- or polycyclic aromatic radical having 6 to 30 carbon atoms or a linear or branched aliphatic radical having 2 to 30 carbon atoms, each of which may be substituted or unsubstituted, and bridged or unbridged.

Preferably, R¹, R², R³ and R⁴ are independently branched or unbranched C₁—to C₄-alkyl, phenyl, naphthyl or C₁—to C₄-alkyl-substituted phenyl. In the case of aromatic R¹, R², R³ and/or R⁴ groups, these may in turn be substituted by halogen and/or alkyl groups, preferably chlorine, bromine and/or C₁—to C₄-alkyl, branched or unbranched. Particularly preferred aryl radicals are cresyl, phenyl, xylenyl, propylphenyl or butylphenyl, and the corresponding brominated and chlorinated derivatives thereof.
X in formula (10) is preferably derived from dihydroxyaryl compounds.
X in formula (10) is particularly preferably

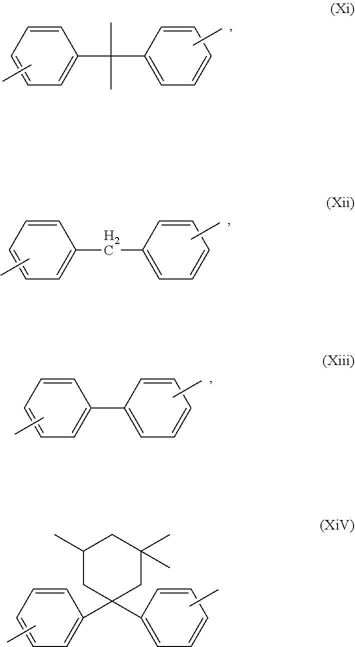

or the chlorinated and/or brominated derivatives thereof. X (together with the adjoining oxygen atoms) is preferably derived from hydroquinone, bisphenol A or diphenylphenol. It is likewise preferable for X to be derived from resorcinol. Particularly preferably, X is derived from bisphenol A. n in formula (10) is preferably equal to 1. q is preferably 0 to 20, particularly preferably 0 to 10, and in the case of mixtures is average values from 0.8 to 5.0, preferably 1.0 to 3.0, further preferably 1.05 to 2.00 and particularly preferably from 1.08 to 1.60.

The phosphorus compound of general formula (10) is preferably a compound of the formula (11):

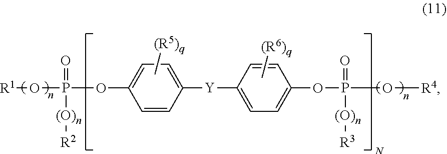

in which
R¹, R², R³ and R⁴ are each independently a linear or branched C₁—to C₈-alkyl radical and/or optionally linear- or branched-alkyl-substituted C₅—to C₆-cycloalkyl radical, C₆—to C₁₀-aryl radical or C₇—to C₁₂-aralkyl radical,
n is independently 0 or 1,
q is independently 0, 1, 2, 3 or 4,
N is a number between 1 and 30,
R⁵ and R⁶ are independently linear or branched C₁—to C₄-alkyl radical, preferably methyl radical, and Y is linear or branched C₁—to C₇-alkylidene, a linear or branched C₁—to C₇-alkylene radical, C₅—to C₁₂-cycloalkylene radical, C₅—to C₁₂-cycloalkylidene radical, —O—, —S—, —SO—, SO₂ or —CO—.

Phosphorus compounds of the formula (10) are in particular tributyl phosphate, triphenyl phosphate, tricresyl phosphate, diphenyl cresyl phosphate, diphenyl octyl phosphate, diphenyl 2-ethylcresyl phosphate, tri (isopropylphenyl)phosphate, resorcinol-bridged oligophosphate and bisphenol A-bridged oligophosphate. If phosphorus compounds of the formula (10) are used, the use of oligomeric phosphoric esters of the formula (10) which are derived from bisphenol A is especially preferred.

Further preference is given to using mixtures of identical structure and different chain length, with the stated q value being the average q value. The average q value is determined by determining the composition of the phosphorus compound mixture (molecular weight distribution) by means of high pressure liquid chromatography (HPLC) at 40° C. in a mixture of acetonitrile and water (50:50) and using this to calculate the average values of q.

Particularly preferably, bisphenol A-based oligophosphate (bisphenol A bis(diphenyl phosphate)) according to formula (12) with q=1 to 20, in particular with q=1.0 to 1.2, is present in the compositions according to the invention.

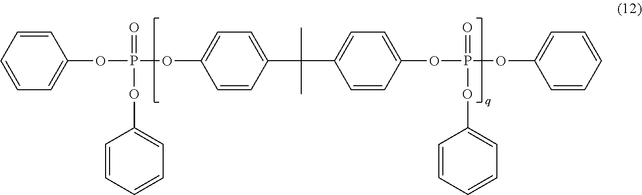

Phosphorus compounds of this kind are known (cf., for example, EP 0 363 608 A1, EP 0 640 655 A2) or can be prepared in an analogous manner by known methods (e.g. Ullmanns Enzyklopädie der technischen Chemie [Ullmann's Encyclopedia of Industrial Chemistry], vol. 18, p. 301 ff., 1979; Houben-Weyl, Methoden der organischen Chemie [Methods of Organic Chemistry], vol. 12/1, p. 43; Beilstein vol. 6, p. 177).

Alternatively, cyclic phosphazenes according to formula (13) are particularly preferably used as component C:

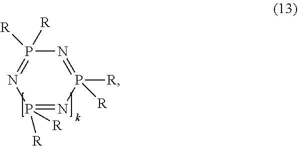

where
R in each case is identical or different and is
   an amine radical,
   an in each case optionally halogenated, preferably fluorine-halogenated, further preferably monohalogenated, C₁—to C₈-alkyl radical, preferably methyl radical, ethyl radical, propyl radical or butyl radical,
   a C₁—to C₈-alkoxy radical, preferably a methoxy radical, ethoxy radical, propoxy radical or butoxy radical,
   an in each case optionally alkyl-substituted, preferably C₁—to C₄-alkyl-substituted, and/or halogen-substituted, preferably chlorine- and/or bromine-substituted, C₅—to C₆-cycloalkyl radical,
   an in each case optionally alkyl-substituted, preferably C₁—to C₄-alkyl-substituted, and/or halogen-substituted, preferably chlorine-, bromine-, and/or hydroxy-substituted, C₆—to C₂₀-aryloxy radical, preferably phenoxy radical, naphthyloxy radical,
   an in each case optionally alkyl-substituted, preferably C₁—to C₄-alkyl-substituted, and/or halogen-substituted, preferably chlorine- and/or bromine-substituted, C₇—to C₁₂-aralkyl radical, preferably phenyl-C₁—to C₄-alkyl radical, or
   a halogen radical, preferably chlorine or fluorine, or
   an OH radical,
k is a whole number from 1 to 10, preferably a number from 1 to 8, particularly preferably 1 to 5, very particularly preferably 1.

Commercially available phosphazenes are preferably used here. These are typically mixtures of rings of different ring sizes.

Further preference is given, either individually or in a mixture, to: propoxyphosphazene, phenoxyphosphazene, methylphenoxyphosphazene, aminophosphazene, fluoroalkylphosphazenes, and also phosphazenes having the following structures:

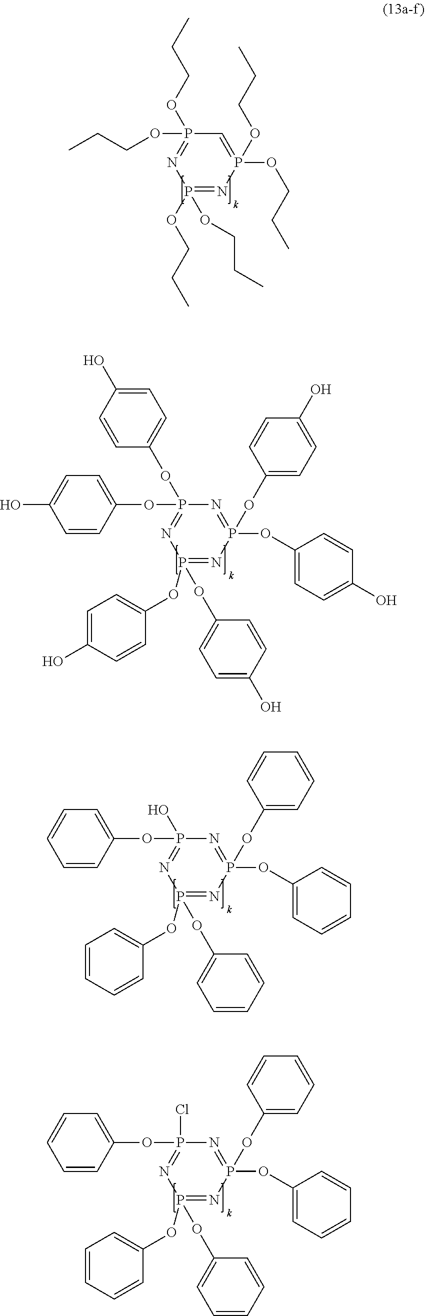

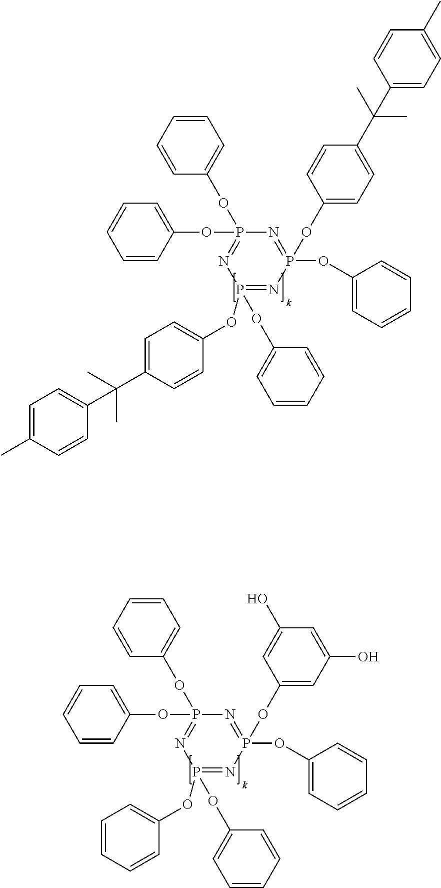

In the compounds 13a-f shown above, k=1, 2 or 3.

Preferably, the proportion of phosphazenes that are halogen-substituted on the phosphorus, for example composed of incompletely reacted starting material, is less than 1000 ppm, further preferably less than 500 ppm.

The phosphazenes can be used alone or in a mixture. The radical R may always be the same or two or more radicals in the formulae may be different. The radicals R of a phosphazene are preferably identical. In one embodiment, solely phosphazenes having the same R are used.

Preferably, the proportion of tetramers (k=2) is from 2 to 50 mol %, based on component B, further preferably from 5 to 40 mol %, further preferably still from 10 to 30 mol %, particularly preferably from 10 to 22 mol %.

Preferably, the proportion of higher oligomeric phosphazenes (k=3, 4, 5, 6 and 7) is from 0 to 30 mol %, based on component B, further preferably from 2.5 to 25 mol %, further preferably still from 5 to 20 mol %, and particularly preferably from 6-15 mol %.

Preferably, the proportion of oligomers with k≥8 is from 0 to 2.0 mol %, based on component B, and preferably from 0.10 to 1.00 mol %.

Further preferably, the phosphazenes of component C satisfy all three above-mentioned conditions with respect to the proportions of oligomers.

Particularly preferably present as component C is phenoxyphosphazene (all R=phenoxy, formula 13 g), alone or with further phosphazenes according to formula (13) as component C, with a proportion of oligomers with k=1 (hexaphenoxyphosphazene) of 50 to 98 mol %, particularly preferably 60 to 72% by weight, based on the amount of phenoxyphosphazene. If phenoxyphosphazene is used, the proportion of oligomers with k=2 is very particularly preferably: 15% to 22% by weight and with k≥3: 10% to 13% by weight.

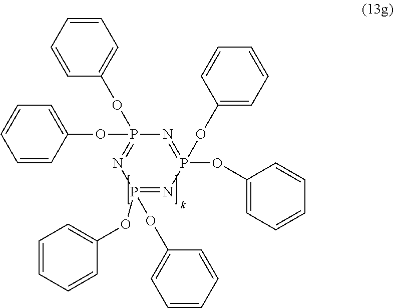

Alternatively, component C very particularly preferably comprises, and very particularly preferably is, a phenoxyphosphazene having a trimer proportion (k=1) of 70 to 85 mol %, a tetramer proportion (k=2) of 10 to 20 mol %, a proportion of higher oligomeric phosphazenes (k=3, 4, 5, 6 and 7) of 3 to 8 mol % and phosphazene oligomers with k≥8 of 0.1 to 1 mol %, based on component C.

In an alternative preferred embodiment, n, defined as the arithmetic mean of k, is in the range from 1.10 to 1.75, preferably from 1.15 to 1.50, further preferably from 1.20 to 1.45, and particularly preferably from 1.20 to 1.40 (range boundaries included).

$$n = \frac{{\sum }_{i = 1}^{max} {k}_{i} \cdot {x}_{i}}{{\sum }_{i = 1}^{max} {x}_{i}} \qquad ( 14 )$$

Phosphazenes and the preparation thereof are described, for example, in EP 728 811 A2, DE 1961668 A and WO 97/40092 A1.

The oligomer compositions in the respective blend samples can be detected and quantified after compounding by means of ³¹P NMR (chemical shift; δ trimer: 6.5 to 10.0 ppm; δ tetramer: −10 to −13.5 ppm; 8 higher oligomers: −16.5 to −25.0 ppm).

Very particularly preferably, component C comprises bisphenol A-based oligophosphate according to formula (12) and/or cyclic phosphazene according to formula (13); most preferably, component C is bisphenol A-based oligophosphate according to formula (12) and/or cyclic phosphazene according to formula (13); exceptionally preferably, component C is cyclic phosphazene according to formula (13).

The proportion of phosphorus-containing flame retardants in the compositions of the invention is at least 2% by weight, based on the overall composition. When the phosphorus-containing flame retardant is an organophosphate, the amount thereof in the composition, based on the overall composition, is 2% to 12% by weight, preferably 2% to 10% by weight, more preferably 2% to 8% by weight. With a smaller proportion of organophosphate in the compositions, it is possible to achieve increasingly higher Vicat temperatures and hence a higher heat distortion resistance. When the phosphorus-containing flame retardant is a phosphazene, the amount thereof in the composition, based on the overall composition, is 2% to 9% by weight, preferably 4% to 8% by weight.

The ratio here of phosphorus-containing flame retardant to PTFE, i.e. the quotient of the amount of component C, i.e. phosphorus-containing flame retardant, and the amount of PTFE, is ≤40, preferably ≤32.

### Component D

The thermoplastic compositions Z may contain one or more further additives other than components B and C, which are referred to collectively in the present context as “component D”.

Optionally (0% by weight), preferably up to 10% by weight, further preferably still 0.1% by weight to 5% by weight, particularly preferably 0.1% by weight to 3% by weight, very particularly preferably 0.2% by weight to 1.0% by weight, of other customary additives (“further additives”) are present, these percentages by weight being based on the total weight of the composition. The group of the further additives does not include any fluorine-containing anti-drip agent according to component B or any phosphorus-containing flame retardant according to component C.

Such further additives, as are typically added to polycarbonates, are in particular thermal stabilizers, antioxidants, demolding agents, UV absorbers, IR absorbers, impact modifiers, antistats, flame retardants different from component C, optical brighteners, light-scattering agents, hydrolysis stabilizers, transesterification stabilizers, (organic) dyes, (organic/inorganic) pigments, for example titanium dioxide, compatibilizers and/or additives for laser marking, in particular in the amounts typical for polycarbonate-based compositions. Such additives are described, for example, in EP 0 839 623 A1, WO 96/15102 A1, EP 0 500 496 A1 or in “Plastics Additives Handbook”, Hans Zweifel, 5th Edition 2000, Hanser Verlag, Munich. These additives may be added individually or else in a mixture and are additives that are preferred according to the invention.

Further preferably present as further additives, if further additives are present at all, are one or more further additives selected from the group consisting of thermal stabilizers, antioxidants, demolding agents, organic dyes, organic pigments, inorganic pigments; exceptionally preferably one or more antioxidants, thermal stabilizers and/or demolding agents.

It will be appreciated that only such additives may be added, and only in such amounts, if they do not significantly negatively impact the effect according to the invention of high CTI and preferably also do not lower the Vicat temperature, determined according to ISO 306:2014-3, VST method B, below 100° C., preferably below 115° C.

The compositions according to the invention may indeed contain, in addition to component C, further flame retardants, but are free of those selected from the group of alkali metal, alkaline earth metal or ammonium salts of aliphatic or aromatic sulfonic acid, sulfonamide or sulfonimide derivatives, and combinations thereof, with “derivatives” being understood to mean those compounds having a molecular structure that in place of a hydrogen atom or a functional group possesses a different atom or a different atom group or in which one or more atoms/atom groups has/have been removed. The parent compound is thus still recognizable.

Such flame retardants that are not present in the compositions according to the invention are in particular one or more compounds selected from the group consisting of sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium diphenylsulfone sulfonate, sodium or potassium 2-formylbenzenesulfonate, sodium or potassium (N-benzenesulfonyl)benzenesulfonamide, or mixtures thereof, among these particularly preferably sodium or potassium perfluorobutanesulfate, sodium or potassium perfluorooctanesulfate, sodium or potassium diphenylsulfone sulfonate, or mixtures thereof, especially potassium perfluoro-1-butanesulfonate, which is commercially available, inter alia, as Bayowet® C₄ from Lanxess, Leverkusen, Germany. It is very particularly preferable for no further flame retardants at all to be present.

Additives that are particularly preferably present are demolding agents, further preferably based on a fatty acid ester, further preferably still based on a stearic ester, especially preferably based on pentaerythritol. Particular preference is given to using pentaerythritol tetrastearate (PETS) and/or glycerol monostearate (GMS). If one or more demolding agents are used, the amount is preferably up to 1.0% by weight (inclusive), further preferably 0.01% to 0.7% by weight, particularly preferably 0.02% to 0.60% by weight, based in each case on the overall composition.

Additives that are particularly preferably present are also thermal stabilizers. The amount of thermal stabilizer is preferably up to 0.20% by weight, further preferably 0.01% to 0.10% by weight, further preferably still 0.01% to 0.05% by weight, particularly preferably 0.015% to 0.040% by weight, based on the overall composition.

Suitable thermal stabilizers are in particular phosphorus-based stabilizers selected from the group of the phosphates, phosphites, phosphonites, phosphines and mixtures thereof. Examples include triphenyl phosphite, diphenyl alkyl phosphite, phenyl dialkyl phosphite, tris(nonylphenyl) phosphite, trilauryl phosphite, trioctadecyl phosphite, distearyl pentaerythritol diphosphite, tris(2,4-di-tert-butylphenyl)phosphite (Irgafos® 168), diisodecyl pentaerythritol diphosphite, bis(2,4-di-tert-butylphenyl) pentaerythritol diphosphite, bis(2,4-dicumylphenyl) pentaerythritol diphosphite (Doverphos® S-9228), bis(2,6-di-tert-butyl-4-methylphenyl) pentaerythritol diphosphite, diisodecyloxy pentaerythritol diphosphite, bis(2,4-di-tert-butyl-6-methylphenyl) pentaerythritol diphosphite, bis(2,4,6-tris(tert-butylphenyl) pentaerythritol diphosphite, tristearyl sorbitol triphosphite, tetrakis(2,4-di-tert-butylphenyl)-4,4′-biphenylenediphosphonite, 6-isooctyloxy-2,4,8,10-tetra-tert-butyl-12H-dibenzo[d,g]-1,3,2-dioxaphosphocine, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyldibenzo[d,g]-1,3,2-dioxaphosphocine, 2,2′,2″-nitrilo [triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, bis(2,6-di-tert-butyl-4-methylphenyl) pentaerythritol diphosphite, triphenylphosphine (TPP), trialkylphenylphosphine, bisdiphenylphosphinoethane or a trinaphthylphosphine. They are used alone or in a mixture with thermal stabilizers or antioxidants, for example Irganox® B900 (mixture of Irgafos® 168 and Irganox® 1076 in a 4:1 ratio) or Doverphos® S-9228 with Irganox® B900 or Irganox® 1076. Especially preferably, triphenylphosphine (TPP), Irgafos® 168 or tris(nonylphenyl) phosphite, or mixtures thereof, are used.

It is also possible to use phenolic antioxidants such as alkylated monophenols, alkylated thioalkylphenols, hydroquinones and alkylated hydroquinones. Particular preference is given to using Irganox® 1010 (pentaerythritol 3-(4-hydroxy-3,5-di-tert-butylphenyl) propionate; CAS: 6683-19-8) and Irganox 1076® (octadecyl 3-(3,5-di-tert-butyl-4-hydroxyphenyl) propionate), preferably in amounts of 0.02%-0.5% by weight.

It is also possible to add sulfonic esters or alkyl phosphates, for example mono-, di- and/or trihexyl phosphate, triisooctyl phosphate and/or trinonyl phosphate, as transesterification inhibitors. The alkyl phosphate used is preferably triisooctyl phosphate (tris-2-ethylhexyl phosphate). It is also possible to use mixtures of various mono-, di- and trialkyl phosphates. Triisooctyl phosphate is preferably used in amounts from 0.003% by weight to 0.05% by weight, further preferably 0.005% by weight to 0.04% by weight and particularly preferably from 0.01% by weight to 0.03% by weight, based on the overall composition.

Examples of impact modifiers are: core-shell polymers such as ABS or MBS; olefin-acrylate copolymers such as the Elvaloy® types from DuPont or Paraloid® types from Dow; silicone acrylate rubbers such as the Metablen® types from Mitsubishi Rayon Co., Ltd. The compositions according to the invention already have an exceptional profile of properties without additional impact modifiers. Compositions according to the invention are therefore preferably free of impact modifiers.

The thermoplastic composition Z comprising the mixed components A, B, C and optionally D can be produced using powder premixes. It is also possible to use premixes of pellet materials or pellet materials and powders with the additions according to the invention. It is also possible to use premixes produced from solutions of the mixture components in suitable solvents, wherein homogenization is optionally effected in solution and the solvent is then removed. More particularly, the additives referred to as component D and also further constituents of the thermoplastic compositions can be introduced by known methods or in the form of a masterbatch. The use of masterbatches is preferred in particular for the introduction of additives and further constituents, with masterbatches based on the respective polymer matrix being used in particular.

The thermoplastic compositions Z may for example be extruded. After extrusion, the extrudate may be cooled and comminuted. The combining and mixing of a premix in the melt may also be effected in the plasticizing unit of an injection molding machine. In this case, the melt is directly converted into a molded article in the subsequent step.

The invention also provides for the use of the combination of 0.25% by weight to 5% by weight of fluorine-containing anti-drip agent containing polytetrafluoroethylene, at least 2% by weight of phosphorus-containing flame retardant, wherein the ratio of phosphorus-containing flame retardant to PTFE is ≤40, preferably ≤32, and wherein, when the phosphorus-containing flame retardant is b1) an organophosphate, the amount of phosphorus-containing flame retardant is 2% to 12% by weight, and, when the phosphorus-containing flame retardant is b2) a phosphazene, the amount of phosphorus-containing flame retardant is 2% to 9% by weight, in order to achieve a CTI, determined in accordance with IEC 60112:2009, of 600 V of an aromatic polycarbonate-based composition, wherein the stated amounts are based on the resulting overall composition.

It will be apparent that the embodiments described above for the thermoplastic composition Z as being preferred etc. are analogously also applicable to the use of the invention.

Various embodiments of the present invention are described below:
1. An EE component, comprising
   a first electrical conductor and a second electrical conductor at a first distance d1 and a second distance d2 with respect to one another,
   which are connected via a thermoplastic composition Z which is in direct contact with the first electrical conductor and the second electrical conductor,
   wherein the distance d1 is the shortest distance between the first electrical conductor and the second electrical conductor along the surface of the thermoplastic material M and
   wherein the distance d2 is the shortest distance between the first electrical conductor and the second electrical conductor through the air, wherein d2 is selected in such a way that at the respective operating voltage a sparkover through the air is prevented,
   wherein d1, at the operating voltage U listed below, is:

$$d 1 i ( 0 V \leq U \leq 250 V ) : 1.3 mm to < 2.5 mm \\ d 1 ii ( 250 V < U \leq 500 V ) = 2.5 mm to < 5. mm \\ d 1 iii ( 500 V < U \leq 1000 V ) = 5. mm to < 10. mm$$

and wherein the thermoplastic composition Z comprises the following components:
   A) at least 80% by weight of aromatic polycarbonate based on bisphenol A,
   B) 0.25% by weight to 5% by weight of fluorine-containing anti-drip agent containing polytetrafluoroethylene,
   C) at least 2% by weight of phosphorus-containing flame retardant,
      wherein the quotient of the amount of phosphorus-containing flame retardant and the amount of polytetrafluoroethylene is ≤40, preferably ≤32, and
      wherein, when the phosphorus-containing flame retardant is b1) an organophosphate,
      the amount of phosphorus-containing flame retardant is 2% to 12% by weight, and, when the phosphorus-containing flame retardant is b2) a phosphazene,
the amount of phosphorus-containing flame retardant is 2% to 9% by weight, and wherein the thermoplastic composition Z is free of flame retardants selected from the group of alkali metal, alkaline earth metal or ammonium salts of aliphatic or aromatic sulfonic acid, sulfonamide or sulfonimide derivatives.
2. The EE component according to embodiment 1, wherein the phosphorus-containing flame retardant is a phosphazene or a mixture of different phosphazenes.
3. The EE component according to embodiment 1, wherein the phosphorus-containing flame retardant comprises a cyclic phosphazene and/or a phosphorus compound of the formula (10).
4. The EE component according to embodiment 1, wherein the phosphorus-containing flame retardant is a cyclic phosphazene and/or a phosphorus compound of the formula (10)

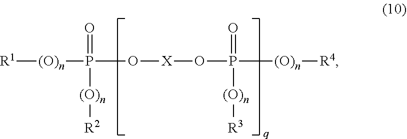

in which
R¹, R², R³ and R⁴ are independently a C₁—to C₈-alkyl radical, in each case optionally halogenated and in each case branched or unbranched, and/or C₅—to C₆-cycloalkyl radical, C₆—to C₂₀-aryl radical or C₇- to C₁₂-aralkyl radical, in each case optionally substituted by branched or unbranched alkyl, and/or halogen, preferably chlorine and/or bromine,
n is independently 0 or 1,
q is a value from 0 to 30 and
X is a mono- or polycyclic aromatic radical having 6 to 30 carbon atoms or a linear or branched aliphatic radical having 2 to 30 carbon atoms, each of which may be substituted or unsubstituted, and bridged or unbridged.
5. The EE component according to embodiment 1 or 3, wherein the phosphorus-containing flame retardant is an organophosphate of the formula (11)

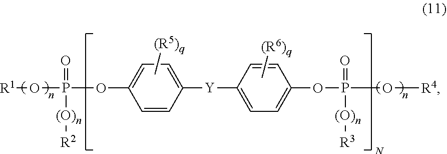

in which
R¹, R², R³ and R⁴ are each independently a linear or branched C₁—to C₈-alkyl radical and/or optionally linear- or branched-alkyl-substituted C₅—to C₆-cycloalkyl radical, C₆—to C₁₀-aryl radical or C₇—to C₁₂-aralkyl radical,
n is independently 0 or 1,
q is independently 0, 1, 2, 3 or 4,
N is a number between 1 and 30,
R⁵ and R⁶ are independently linear or branched C₁—to C₄-alkyl radical, preferably methyl radical, and
Y is linear or branched C₁—to C₇-alkylidene, a linear or branched C₁—to C₇-alkylene radical, C₅— to
C₁₂-cycloalkylene radical, C₅—to C₁₂-cycloalkylidene radical, —O—, —S—, —SO—, SO₂ or —CO—,
or a
phosphazene of the formula (13g)

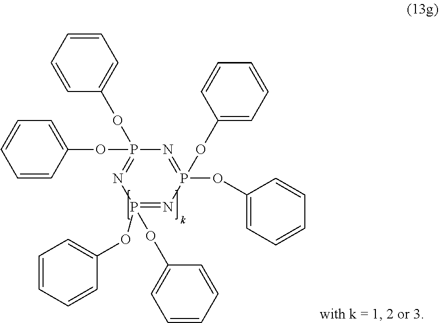

6. The EE component according to embodiment 1, 3 or 4, wherein the cyclic phosphazene is a phosphazene of the formula (13)

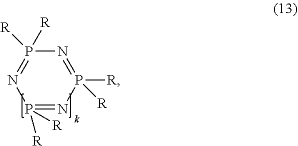

where
R in each case is identical or different and is
   an amine radical,
   an in each case optionally halogenated, preferably fluorine-halogenated, further preferably monohalogenated, C₁—to C₈-alkyl radical, preferably methyl radical, ethyl radical, propyl radical or butyl radical,
   a C₁—to C₈-alkoxy radical, preferably a methoxy radical, ethoxy radical, propoxy radical or butoxy radical,
   an in each case optionally alkyl-substituted, preferably C₁—to C₄-alkyl-substituted, and/or halogen-substituted, preferably chlorine- and/or bromine-substituted, C₅—to C₆-cycloalkyl radical,
   an in each case optionally alkyl-substituted, preferably C₁—to C₄-alkyl-substituted, and/or halogen-substituted, preferably chlorine-, bromine-, and/or hydroxy-substituted, C₆—to C₂₀-aryloxy radical, preferably phenoxy radical, naphthyloxy radical,
   an in each case optionally alkyl-substituted, preferably C₁—to C₄-alkyl-substituted, and/or halogen-substituted, preferably chlorine- and/or bromine-substituted, C₇—to C₁₂-aralkyl radical, preferably phenyl-C₁—to C₄-alkyl radical, or
   a halogen radical, preferably chlorine or fluorine, or
   an OH radical,
k is a whole number from 1 to 10, preferably a number from 1 to 8, particularly preferably 1 to 5, very particularly preferably 1.
7. The EE component according to embodiment 3 or 4, wherein the phosphorus compound of the formula (10) is a bisphenol A-based oligophosphate of the formula (12)

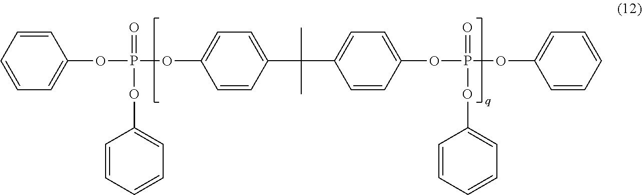

with q=1 to 20, in particular with q=1.0 to 1.2.
8. The EE component according to any of embodiments 1 to 7, with an IP6K9K degree of protection according to ISO 20653:2013-02.
9. The EE component according to any of embodiments 1 to 8, wherein d2 ≥1.2 mm.
10. The EE component according to any of the preceding embodiments, wherein the aromatic polycarbonate is bisphenol A-based homopolycarbonate.
11. The EE component according to any of the preceding embodiments, wherein the thermoplastic composition Z also contains:
   D) one or more additives selected from the group consisting of demolding agents, thermal stabilizers, antioxidants, dyes, impact modifiers, pigments, UV absorbers, IR absorbers, optical brighteners, hydrolysis stabilizers, transesterification stabilizers, compatibilizers, additives for laser marking, flow improvers and mixtures thereof.
12. The EE component according to any of embodiments 1 to 10, wherein the thermoplastic composition Z also contains: one or more additives selected from the group consisting of demolding agents, thermal stabilizers, antioxidants, dyes, pigments, transesterification stabilizers, flow improvers and mixtures thereof.
13. The EE component according to any of the preceding embodiments, wherein the thermoplastic composition does not comprise any further constituents.
14. The EE component according to any of embodiments 1 to 4, 6 and 8 to 13, wherein the phosphorus-containing flame retardant is a phosphazene and the amount thereof is 4% to 8% by weight of the overall composition.
15. The EE component according to any of embodiments 1, 3 to 5 and 7 to 13, wherein the phosphorus-containing flame retardant is an organophosphate and the amount thereof is 2% to 10% by weight of the overall composition.
16. The EE component according to any of the preceding embodiments, wherein the EE component is part of a high-voltage switch, inverter, relay, electronic connector, electrical connector, circuit breaker, a photovoltaic system, an electric motor, a heat sink, a charger or charging plug for electric vehicles, an electrical junction box, a smart meter housing, a miniature circuit breaker, a busbar.
17. The EE component according to any of the preceding embodiments, wherein

$$d 1 i ( 0 V \leq U \leq 250 V ) : 1.3 mm to < 1.8 mm \\ d 1 ii ( 250 V < U \leq 500 V ) = 2.5 mm to < 3.6 mm \\ d 1 iii ( 500 V < U \leq 1000 V ) = 5. mm to < 7.1 mm .$$

18. The EE component according to any of the preceding embodiments, wherein the EE component is designed for an operating voltage of at least 400 V.
19. The EE component according to any of the preceding embodiments, wherein the thermoplastic composition Z, as well as components A, B and C, comprises, as component D, solely one or more thermal stabilizers, antioxidants, demolding agents, dyes, pigments and mixtures thereof.
20. The EE component according to any of the preceding embodiments, wherein the thermoplastic composition Z has a CTI of 600 V, determined in accordance with IEC 60112:2009.
21. An EE assembly comprising an EE component according to any of the preceding embodiments, wherein the EE assembly has an IP6K9K degree of protection according to ISO 20653:2013-02.
22. An EE assembly wherein the operating voltage of the EE assembly is at least 400 V.
23. The EE assembly according to either of embodiments 21 and 22 for the field of electromobility.
24. The use of a thermoplastic composition as defined as part of any of embodiments 1 to 15 in order to achieve a CTI, determined in accordance with IEC 60112:2009, of 600 V of an aromatic polycarbonate-based composition containing at least 80% by weight of aromatic polycarbonate, based on bisphenol A, wherein the stated amount is based on the resulting overall composition.
25. The use according to embodiment 24, wherein the aromatic polycarbonate is bisphenol A-based homopolycarbonate.

### Examples

### 1. Description of Raw Materials and Test Methods

### a) Raw Materials

Component A-1: Linear polycarbonate based on bisphenol A having a melt volume flow rate of 12 cm³/(10 min) (according to ISO 1133:2012-03, at a test temperature of 300° C. and with 1.2 kg load) containing as component D-3 250 ppm (=0.025% by weight, based on the total weight of component A) of triphenylphosphine thermal stabilizer.

Component A-2: Linear polycarbonate based on bisphenol A having a melt volume flow rate of 6 cm³/(10 min) (according to ISO 1133:2012-03, at a test temperature of 300° C. and with 1.2 kg load).

Component B-1: ADS5000 SAN-encapsulated polytetrafluoroethylene (approx. 50% by weight PTFE (fluorine-containing anti-drip agent) and approx. 50% by weight SAN) from Chemical Innovation Co., Ltd Thailand.

Component B-2: Fluorine-containing anti-drip agent. Teflon CFP6000X polytetrafluoroethylene from Chemours Netherlands B.V.

Component C-1: Organophosphate of the formula (12) with q=1.0-1.2. Bisphenol A bis(diphenyl phosphate) from Adeka.

Component C-2: Rabitle FP110 phenoxycyclophosphazene from Fushimi Pharmaceutical, Japan, formula (13g), with a trimer proportion (k=1) of approximately 68 mol %.

Component C-x: Potassium perfluoro-1-butanesulfonate, commercially available as Bayowet® C₄ from Lanxess AG, Leverkusen, Germany, CAS no. 29420-49-3.

Component D-1: Demolding agent. Pentaerythritol tetrastearate, commercially available as Loxiol VPG 861 from Emery Oleochemicals Group.

Component D-2: Mixture of thermal stabilizer and antioxidant. Irganox® B900 from BASF (mixture of Irgafos® 168 (tris(2,4-di-tert-butylphenyl)phosphite) and Irganox® 1076 (octadecyl 3-(3,5-di-tert-butyl-4-hydroxyphenyl) propionate) in a 4:1 ratio by weight).

b) Test methods
Comparative tracking index (CTI):

In order to determine the comparative tracking index, the compositions described here were tested according to the rapid test method based on IEC 60112:2009. To this end, a 0.1% ammonium chloride test solution (395 ohm*cm resistance) was applied dropwise, between two neighboring electrodes spaced apart by 4 mm, to the surface of test specimens of dimensions 60 mm×40 mm×4 mm at a time interval of 30 s. A test voltage was applied between the electrodes and was varied over the course of the test. The first test specimen was tested at a starting voltage of 300 V or 350 V. A maximum of 50 drops (one drop every 30 s) in total were applied per voltage as long as no tracking current >0.5 A over 2 s occurred or the sample burned. After 50 drops, the voltage was increased by 50 V and a new test specimen was tested at this higher voltage, according to the procedure described above. This process was continued until either 600 V was reached or a tracking current or burning occurred. If one of the above-mentioned effects already occurred with fewer than 50 drops, the voltage was reduced by 25 V and a new test specimen was tested at this lower voltage. The voltage was reduced until the test was passed with 50 drops without tracking current or burning. This procedure was therefore used to determine the maximum possible voltage at which a composition was able to withstand 50 drops of the test solution without occurrence of a tracking current. Lastly, four further test specimens were tested at the determined maximum voltage with 50 drops each for confirmation. This confirmed value is reported as the CTI in the examples. A 100-drop value was not determined, hence “rapid test method based on” the specified standard.

### Flame Retardancy:

The flame retardancy of the polycarbonate compositions was tested according to Underwriters Laboratories method UL 94 V in thicknesses of 2 mm. The tested test bars were conditioned beforehand for 7 days at 20% relative humidity and 70° C. ambient temperature.

Various fire classes are assigned depending on the behavior of the test specimens. This includes the time until the flame is extinguished, resistance to dripping, or whether a material produces burning drips. The classes determined hereafter are designated V0, V1 and V2 and are ascertained on the basis of a total of five tested test specimens.
V0: The test specimen, positioned with its longitudinal axis 180° (vertical) to the flame, has an average afterflame time after removal of the flame of not more than 10 s and does not produce any dripping plastic particles that ignite cotton wool located under the test specimen. The total afterflame time of five test specimens, in each case with two times flame application, is at most 50 s.
V1: In contrast to VO, the average maximum afterflame time here is <30 s, and here too no dripping particles or ignition of the cotton wool are permitted. The total afterflame time of five test specimens, in each case with two times flame application, is <250 s.
V2: In contrast to VO and V1, dripping plastic particles that ignite the cotton wool are formed in this classification. The individual afterflame times are <30 s and the total afterflame time of 5 test specimens, in each case with two times flame application, is <250 s.
f.: The test does not deliver a flame retardancy classification if the afterflame times are exceeded.

### Heat Distortion Resistance:

The heat distortion resistance of the compositions was determined on the basis of the Vicat softening temperature (method B, test force 50 N, heating rate 50 K/h) on test specimens having the dimensions 80 mm×10 mm×4 mm according to ISO 306:2014-3.

### 2. Production of the Test Specimens

The compositions were prepared on a 25 mm twin-screw extruder from Coperion with a throughput of 20 kg/h. The temperatures of the polymer melt in the extruder were between 260-280° C. with an average screw speed of 225 rpm.

The test specimens having the dimensions 60 mm×40 mm×4 mm were produced from the molding compounds using standard injection molding methods at a melt temperature of 280° C. and a mold temperature of 80° C.

### Results

In the tables below, “n.t.” means “not tested”. The symbol “*” means “taken from UL Yellow Card”.

TABLE 1

| Component | | V-1 | V-2 | E-3 | E-4 | V-5 | E-6 | E-7 | V-8 | E-9 | E-10 | E-11 | E-12 | E-13 |
|---|---|---|---|---|---|---|---|---|---|---|---|---|---|---|
| A-1 | % by wt. | 100 | 99.4 | 95.9 | 94.9 | 95.4 | 95.5 | 90.9 | 86.9 | 96.4 | 94.4 | 91.4 | 93.4 | 83.4 |
| A-2 | % by wt. | | | | | | | | | | | | | |
| B-1 | % by wt. | | | 0.5 | 0.5 | | 0.5 | 0.5 | 0.5 | 1 | 1 | 4 | 4 | 4 |
| B-2 | % by wt. | | | | | | | | | | | | | |
| C-1 | % by wt. | | | 3 | 4 | 4 | 4 | 8 | 12 | 2 | 4 | 4 | 2 | 12 |
| C-2 | % by wt. | | | | | | | | | | | | | |
| C-x | % by wt. | | | | | | | | | | | | | |
| D-1 | % by wt. | | 0.5 | 0.5 | 0.5 | 0.5 | | 0.5 | 0.5 | 0.5 | 0.5 | 0.5 | 0.5 | 0.5 |
| D-2 | % by wt. | | 0.1 | 0.1 | 0.1 | 0.1 | | 0.1 | 0.1 | 0.1 | 0.1 | 0.1 | 0.1 | 0.1 |
| CTI | V | 250 | 300 | 600 | 600 | 225 | 600 | 600 | 275 | 600 | 600 | 600 | 600 | 600 |
| UL94 | 2 mm | V2* | V2 | V0 | V0 | V2 | V0 | V0 | V0 | V0 | V0 | V0 | V0 | V0 |
| Overall result | | | | | | | | | | | | | | |
| Vicat | ° C. | 144 | 141 | 130 | 127 | 128 | 130 | 116 | 105 | 132 | 126 | 125 | 130 | 103 |
| temperature | | | | | | | | | | | | | | |

TABLE 2

| Component | | E-14 | E-15 | E-16 | E-17 | V-18 | E-19 | E-20 | E-21 | E-22 | V-23 | V-24 | V-25 | V-26 |
|---|---|---|---|---|---|---|---|---|---|---|---|---|---|---|
| A-1 | % by wt. | 94.9 | 92.4 | 91.4 | 87.4 | 85.4 | 95.1 | 94.4 | 95.0 | 93.4 | 99.35 | 98.85 | 95.35 | 94.85 |
| A-2 | % by wt. | | | | | | | | | | | | | |
| B-1 | % by wt. | 0.5 | 3 | 4 | 4 | 4 | | | | | | 0.5 | 4 | 0.5 |
| B-2 | % by wt. | | | | | | 0.3 | 1 | 1 | 2 | | | | |
| C-1 | % by wt. | | | | | | 4 | 4 | 4 | 4 | | | | 4 |
| C-2 | % by wt. | 4 | 4 | 4 | 8 | 10 | | | | | | | | |
| C-x | % by wt. | | | | | | | | | | 0.05 | 0.05 | 0.05 | 0.05 |
| D-1 | % by wt. | 0.5 | 0.5 | 0.5 | 0.5 | 0.5 | 0.5 | 0.5 | | 0.5 | 0.5 | 0.5 | 0.5 | 0.5 |
| D-2 | % by wt. | 0.1 | 0.1 | 0.1 | 0.1 | 0.1 | 0.1 | 0.1 | | 0.1 | 0.1 | 0.1 | 0.1 | 0.1 |
| CTI | V | 600 | 600 | 600 | 600 | 275 | 600 | 600 | 600 | 600 | 200 | 225 | 250 | 200 |
| UL94 | 2 mm | V0 | V0 | V0 | V0 | V0 | V0 | V0 | n.t. | V0 | V2 | V0 | V0 | V0 |
| Overall result | | | | | | | | | | | | | | |
| Vicat | ° C. | 131 | 129 | 129 | 119 | 118 | n.t. | 127 | 130 | 127 | 140 | 140 | 138 | 127 |
| temperature | | | | | | | | | | | | | | |

The examples compiled in tables 1 and 2 comprise compositions composed of polycarbonate, anti-drip agent (PTFE/SAN) and flame retardant, and also further additives. If small amounts of a phosphorus-based flame retardant, for example BDP, together with PTFE are added, it is possible to achieve not only a CTI of 600 V but also a VO classification at low wall thicknesses, which constitute an attractive package of properties for aforementioned applications (see E-3 to E-13). The flame retardant on its own does not result in an improvement in CTI compared to a non-FR polycarbonate composition (cf. V-5 with V-2). Larger amounts of flame retardant have to be balanced by larger amounts of anti-drip agent in order to obtain the CTI of 600 V (cf. E-13 with V-8). The further results in table 2 comprise compositions with phosphazene as flame retardant (see E-14-E-17), which likewise achieve a high CTI and a VO classification. Moreover, corresponding compositions with pure PTFE rather than a PTFE/SAN masterbatch are included, which, based on the total PTFE content of the compositions, likewise achieve a CTI of 600 V and VO (see E-19 to E-22). Finally, comparative examples V-23 to V-26 show that inorganic flame retardants based on alkylsulfonates, for example, do not lead to high tracking current resistance.

1. An EE component, comprising
a first electrical conductor and a second electrical conductor at a first distance d1 and a second distance d2 with respect to one another,
which are connected via a thermoplastic composition Z which is in direct contact with the first electrical conductor and the second electrical conductor,
wherein the distance d1 is the shortest distance between the first electrical conductor and the second electrical conductor along the surface of the thermoplastic material M and
wherein the distance d2 is the shortest distance between the first electrical conductor and the second electrical conductor through the air, wherein d2 is selected in such a way that at the respective operating voltage a sparkover through the air is prevented,
wherein d1, at the operating voltage U listed below, is:
$$d 1 i ( 0 V \leq U \leq 250 V ) : 1.3 mm to < 2.5 mm \\ d 1 ii ( 250 V < U \leq 500 V ) = 2.5 mm to < 5. mm \\ d 1 iii ( 500 V < U \leq 1000 V ) = 5. mm to < 10. mm .$$
and wherein the thermoplastic composition Z comprises the following components:
A) at least 80% by weight of aromatic polycarbonate based on bisphenol A,
B) 0.25% by weight to 5% by weight of fluorine-containing anti-drip agent containing polytetrafluoroethylene,
C) at least 2% by weight of phosphorus-containing flame retardant,
wherein the quotient of the amount of phosphorus-containing flame retardant and
the amount of polytetrafluoroethylene is ≤40 and
wherein, when the phosphorus-containing flame retardant is
b1) an organophosphate,
the amount of phosphorus-containing flame retardant is 2% to 12% by weight,
and, when the phosphorus-containing flame retardant is
b2) a phosphazene,
the amount of phosphorus-containing flame retardant is 2% to 9% by weight,
and wherein the thermoplastic composition Z is free of flame retardants selected from the group of alkali metal, alkaline earth metal or ammonium salts of aliphatic or aromatic sulfonic acid, sulfonamide or sulfonimide derivatives.

2. The EE component as claimed in claim 1, wherein the phosphorus-containing flame retardant is an organophosphate of the formula (11) 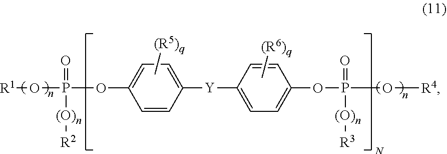
in which
R¹, R², R³ and R⁴ are each independently a linear or branched C₁—to C₈-alkyl radical and/or optionally linear- or branched-alkyl-substituted C₅—to C₆-cycloalkyl radical, C₆—to C₁₀-aryl radical or C₇—to C₁₂-aralkyl radical,
n is independently 0 or 1,
q is independently 0, 1, 2, 3 or 4,
N is a number between 1 and 30,
R₅ and R₆ are independently linear or branched C₁—to C₄-alkyl radical, and
Y is linear or branched C₁—to C₇-alkylidene, a linear or branched C₁—to C₇-alkylene radical, C₅—to C₁₂-cycloalkylene radical, C₅—to C₁₂-cycloalkylidene radical, —O—, —S—, —SO—, SO₂ or —CO—,
or a
phosphazene of the formula (13g)

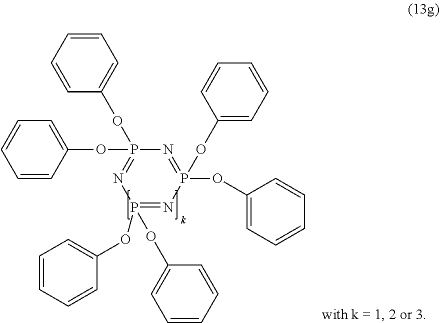

3. The EE component as claimed in claim 1, wherein the aromatic polycarbonate is bisphenol A-based homopolycarbonate.

4. The EE component as claimed in claim 1, wherein the thermoplastic composition also contains:
D) one or more additives selected from the group consisting of demolding agents, thermal stabilizers, antioxidants, dyes, impact modifiers, pigments, UV absorbers, IR absorbers, optical brighteners, hydrolysis stabilizers, transesterification stabilizers, compatibilizers, additives for laser marking, flow improvers and mixtures thereof.

5. The EE component as claimed in claim 1, wherein the thermoplastic composition Z, as well as components A, B and C, comprises, as component D, solely one or more thermal stabilizers, antioxidants, demolding agents, dyes, pigments and mixtures thereof.

6. The EE component as claimed in claim 1, wherein the EE component is part of a high-voltage switch, inverter, relay, electronic connector, electrical connector, circuit breaker, a photovoltaic system, an electric motor, a heat sink, a charger or charging plug for electric vehicles, an electrical junction box, a smart meter housing, a miniature circuit breaker, or a busbar.

7. The EE component as claimed in claim 1, wherein
$$d 1 i ( 0 V \leq U \leq 250 V ) : 1.3 mm to < 1.8 mm \\ d 1 ii ( 250 V < U \leq 500 V ) = 2.5 mm to < 3.6 mm \\ d 1 iii ( 500 V < U \leq 1000 V ) = 5. mm to < 7.1 mm .$$

8. The EE component as claimed in claim 1, wherein the EE component is designed for an operating voltage of at least 400 V.

9. The EE component as claimed in claim 1, wherein the thermoplastic composition does not comprise any further constituents.

10. The EE component as claimed in claim 1, wherein the thermoplastic composition Z contains 4% to 8% by weight of cyclophosphazene.

11. An EE assembly comprising an EE component as claimed in claim 1, wherein the EE assembly has an IP6K9K degree of protection according to ISO 20653:2013-02.

12. The EE assembly as claimed in claim 11, wherein the operating voltage of the EE assembly is at least 400 V.

13. A method for achieving a CTI, determined in accordance with IEC 60112:2009, of 600 V of an aromatic polycarbonate-based composition containing at least 80% by weight of aromatic polycarbonate, based on bisphenol A, wherein the stated amounts are based on the resulting overall composition, by providing the combination of:
0.25 % by weight to 5% by weight of fluorine-containing anti-drip agent containing polytetrafluoroethylene,
at least 2% by weight of phosphorus-containing flame retardant,
wherein the ratio of phosphorus-containing flame retardant to PTFE is ≤40 and
wherein, when the phosphorus-containing flame retardant is
b1) an organophosphate,
the amount of phosphorus-containing flame retardant is 2% to 12% by weight,
and, when the phosphorus-containing flame retardant is
b2) a phosphazene,
the amount of phosphorus-containing flame retardant is 2% to 9% by weight.
